(19) United States
(12) Patent Application Publication
(10) Pub. No.: US 2007/0283918 A1
(43) Pub. Date: Dec. 13, 2007

(54) Combination Bearing Beam and Crankshaft-Interactive Oil Management Device for Internal Combustion Engine

(75) Inventors: Michael Deegan, Farmington Hills, MI (US); Daryl Self, Trenton, MI (US); Joseph Stout, Royal Oak, MI (US); Emmett Holmes, Livonia, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/422,636

(22) Filed: Jun. 7, 2006

(51) Int. Cl. F02F 7/00; F02B 75/22; F01M 1/02

(52) U.S. Cl. 123/195 H; 123/196 R; 123/55.6

(57) ABSTRACT

A combination bearing beam and crankshaft-interactive oil management device for an internal combustion engine includes longitudinally and laterally extending beam elements attached to the engine's main bearing caps. Baffle members extend between the beam elements and include not only scraper elements for capturing oil adhering to the engine's rotating assembly, but also windows for allowing captured oil to flow into the engine's oil sump.

### BACKGROUND OF THE INVENTION

1. Field of the Invention

The present invention relates to a combination bearing beam and crankshaft-interactive oil management device which provides longitudinal and torsional stiffness for a cylinder block of an engine, while also removing excess oil from the counterweights and large ends of the engine's connecting rods, while additionally minimizing direct contact between oil within the crankcase sump and the rotating crankshaft.

2. Disclosure Information

High performance engine builders have used crankshaft windage trays for many years. Such windage trays have typically been constructed from stamped metal and offered no structural enhancement to the engine's cylinder block. Bearing beams have also been employed with various engines to satisfy the objective of strengthening the bottom end of the engine. Such bearing beams have not, however, provided any substantive improvement in terms of removing engine oil away from the rotating assembly, while minimizing contact between the rotating assembly and oil carried within the crankcase sump.

It is desirable to keep engine oil within the crankcase sump from coming into direct contact with the rotating crankshaft and the large, or bottom, ends of the connecting rods, because such contact promotes unwanted aeration of the oil and consumes power through a churning type of action.

The present device provides not only longitudinal and torsional strengthening of the cylinder block by connecting the main bearing caps, but also provides the additional advantage of separating oil from the rotating assembly, including both the crankshaft counterweights and the large ends of the connecting rods, while also avoiding direct contact between oil contained within the crankcase sump and the rotating crankshaft.

### SUMMARY OF THE INVENTION

A combination bearing beam and crankshaft-interactive oil management device for an internal combustion engine includes a number of longitudinally extending beam elements fastened to the engine's main bearing caps. Laterally extending beam elements are formed integrally with the longitudinally extending beam elements. The laterally extending beam elements generally underlie the main bearing caps of the engine. The longitudinally extending beam elements are fastened to the main bearing caps by means of fasteners passing through the beam elements and through the main bearing caps and into a cylinder block of the engine. The present combination bearing beam and crankshaft-interactive oil management device also includes a number of baffle members extending between the longitudinally and laterally extending beam elements. The baffle members define a number of scrapers for capturing oil adhered to the rotating assembly, in this case a crankshaft. The baffle members and longitudinally and laterally extending beam elements are part of an integral assembly which preferably comprises a single cast metal part.

According to another aspect of the present invention, the crankshaft scrapers include scrapers for removing oil adhering to a plurality of crankshaft counterweights, and other scrapers for removing oil adhering to the large ends of the engine's connecting rods. A number of windows are formed in the baffle members. These windows cooperate with the scrapers to cause oil captured by the scrapers to flow through the windows and into the crankcase sump. The scrapers are supported robustly by the laterally extending beam elements.

According to another aspect of the present invention, an internal combustion engine includes a cylinder block, a crankshaft, a number of main bearing caps for mounting the crankshaft within the cylinder block, and a combination bearing beam and crankshaft-interactive oil management device with the previously described longitudinally and laterally extending beam elements, as well as baffle members and scrapers for capturing oil adhering to the crankshaft as the crankshaft rotates. The baffle members also include separator elements for minimizing direct contact between oil within the crankcase sump and the crankshaft.

It is an advantage of a bearing beam and oil management device according to the present invention that not only will torsional and longitudinal rigidity be imparted to an engine, but also engine power will be increased because of the lack of crankshaft windage, which is defined as the tendency of a crankshaft to whip up oil contained within the crankcase sump.

It is an advantage of a bearing beam and oil management device according to the present invention that direct contact between the oil within the crankcase sump and the crankshaft is minimized.

It is yet another advantage of a combination bearing beam and oil management device according to the present invention that an engine equipped with the present device will be quieter because of the absence of vibrations damped by the additional torsional and longitudinal strengthening provided by the bearing beam feature of this device.

Other advantages, as well as features and objects of the present invention will become apparent to the reader of this specification.

### BRIEF DESCRIPTION OF THE DRAWINGS

FIG. 1 is a perspective view of an engine block having a combination bearing beam and crankshaft-interactive oil management device according to the present invention.

FIG. 2 is a view from underneath the engine block of FIG. 1 showing the present combination bearing beam and oil management device.

FIG. 3 is a perspective view of the lower face of the present combination bearing beam and oil management device.

FIG. 4 is a perspective view of the inside region of the present combination bearing beam and oil management device.

FIG. 5 is a perspective view illustrating the present combination bearing beam and oil management device having a series of main bearing caps situated in the manner in which the bearing beam and bearing caps are installed in the engine.

FIG. 6 is similar to FIG. 5 but shows an inside view of the present combination bearing beam and oil management device with a number of engine main bearing caps.

FIG. 7 is a sectional view through the crankshaft of an engine, showing baffles and scrapers incorporated in the present device.

FIG. 8 illustrates a section through a crankshaft and through the combination bearing beam and oil management device showing the large end of a connecting rod and a scraper and baffles incorporated in the present device.

### DETAILED DESCRIPTION OF THE PREFERRED EMBODIMENTS

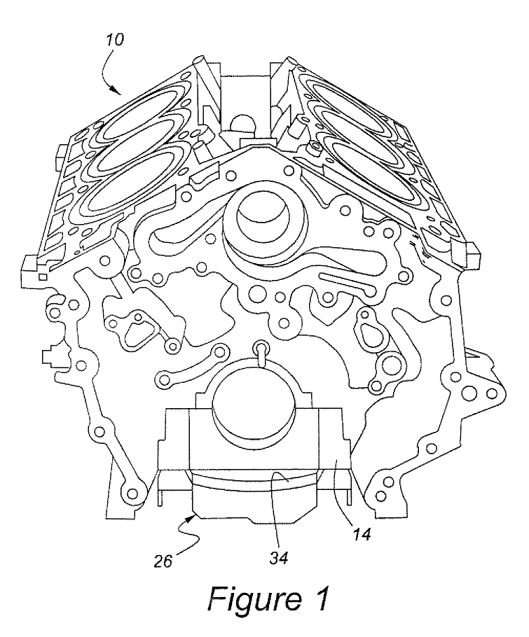

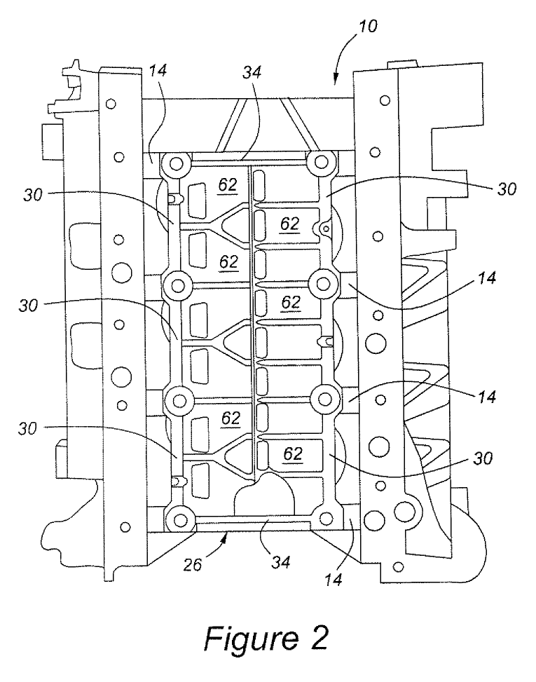

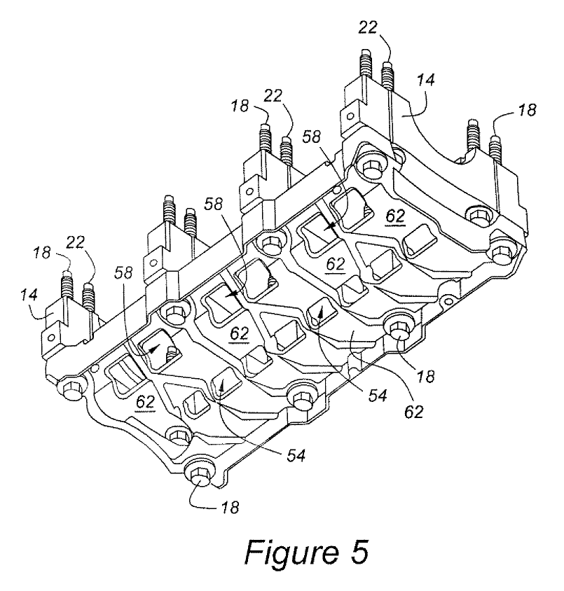

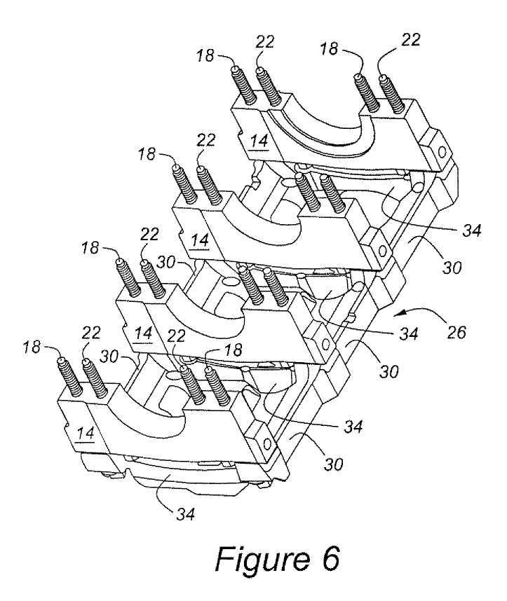

As shown in FIG. 1, cylinder block 10 has bearing cap 14 mounted thereto. Bearing beam and crankshaft-interactive oil management device 26 is mounted to a lower surface of main bearing cap 14. The mounting of device 26 is shown with further specificity in FIGS. 2, 5 and 6. With specific reference to FIGS. 5 and 6, it is noted that main bearing caps 14 are mounted by two inner rows of cap screws, 22, and two outer rows of cap screws, 18. Cap screws 18 are also used for the purpose of attaching or mounting bearing beam 26 to main bearing caps 14 and cylinder block 10. It is easily seen from FIGS. 5 and 6 that cap screws 18 extend not only through bearing beam and oil management device 26, but also through the outermost mounting holes of main bearing caps 14 and into threaded bores (not shown) formed in cylinder block 10.

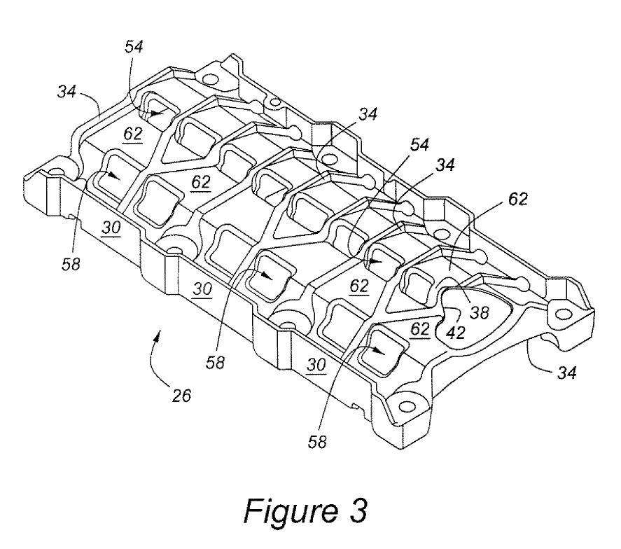

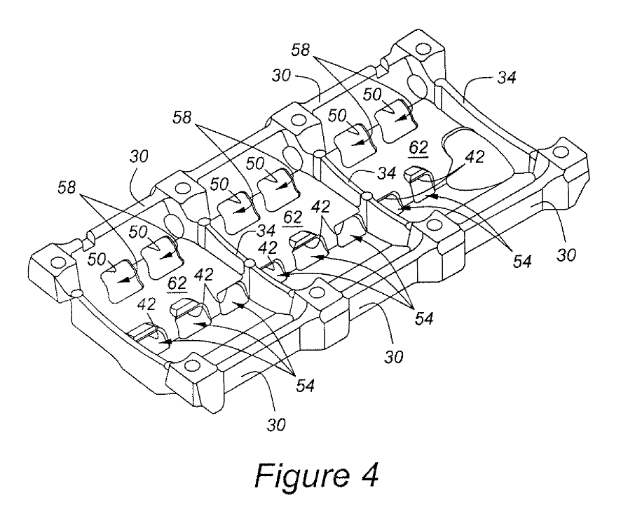

As seen in FIG. 2, as well as in FIGS. 3 and 4, combination bearing beam and oil management device 26 has a number of laterally extending beam elements, which underlie main bearing caps 14. Beam elements 34 help to strengthen the engine block 10 torsionally. Longitudinal rigidity is imparted by longitudinally extending beam elements 30, which are shown in FIGS. 2, 3 and 4, as well as in FIGS. 5 and 6. Beam elements 30 and 34 are part of an integral assembly, which preferably comprises cast metal, which could be either die cast, sintered or alternatively, machined billet material. In any event, beam elements 30 and 34 function to reduce engine noise by preventing unwanted vibration.

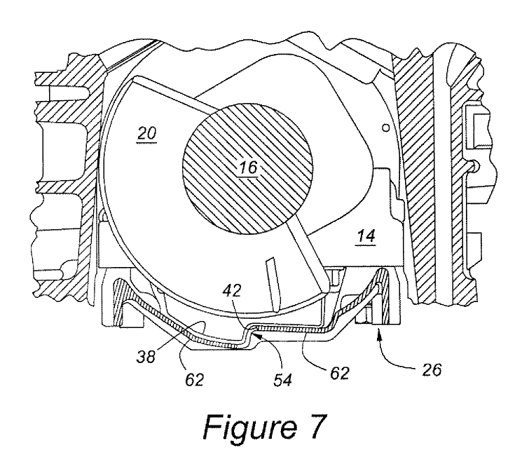

The avoidance of unwanted noise and vibration is only part of the function of bearing beam and oil management device 26. As shown in FIGS. 3, 4 and 5, a number of windows, 54 and 58, are formed in device 26. Windows 54 cooperate with counterweight scrapers 42, as shown in FIG. 7, to direct oil captured by scrapers 42 into a crankcase sump which underlies cylinder block 10.

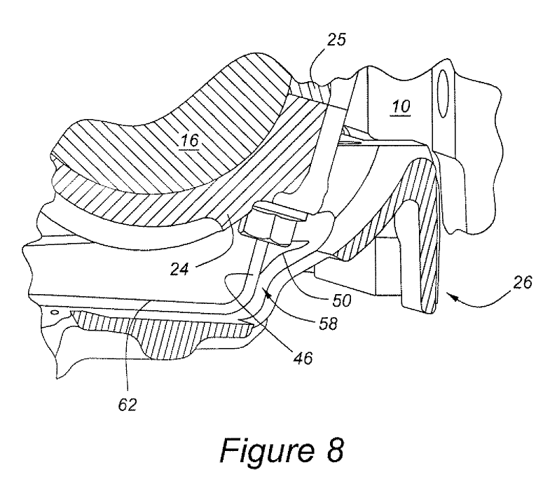

In FIG. 8, large end 24 of connecting rod 25 is shown in proximity to window 58 formed in bearing beam 26. Window 58 cooperates with connecting rod baffle 46 and connecting rod scraper 50 to remove oil from the large end 24 of the connecting rod and to direct the oil into the engine's sump.

Various figures, particularly FIGS. 3, 4 and 5 show separator elements 62 which minimize direct contact between oil within the crankcase sump and crankshaft 16. As described above, this is important to prevent windage, or the unwanted interaction between oil vapor, mist, and liquid splashed within the crankcase sump and onto the rotating crankshaft. In this manner, the engine horsepower output will be increased, and unwanted aeration of the oil, which is sometimes accompanied by a loss of lubrication effectiveness, will also be avoided.

While particular embodiments of the invention have been shown and described, numerous variations and alternate embodiments will occur to those skilled in the art. Accordingly, it is intended that the invention be limited only in terms of the appended claims.

1. A combination bearing beam and crankshaft-interactive oil management device for an internal combustion engine, comprising:
a plurality of longitudinally extending beam elements fastened to a plurality of main bearing caps; and
a plurality of laterally extending beam elements formed integrally with said longitudinally extending beam elements, with one of said laterally extending beam elements underlying each of said main bearing caps; and
a plurality of baffle members extending between said longitudinally and laterally extending beam elements, with said baffle members defining a plurality of scrapers for capturing oil adhered to a rotating assembly.

2. A combination bearing beam and crankshaft-interactive oil management device according to claim 1, wherein said longitudinally extending beam elements are fastened to said main bearing caps by means of fasteners passing through the beam elements and through the main bearing caps and into a cylinder block of the engine.

3. (canceled)

4. A combination bearing beam and crankshaft-interactive oil management device according to claim 1, wherein said baffle members and said longitudinally and laterally extending beam elements are part of an integral assembly.

5. A combination bearing beam and crankshaft-interactive oil management device according to claim 4, wherein said integral assembly comprises a single cast metal part.

6. A combination bearing beam and crankshaft-interactive oil management device according to claim 1, wherein said scrapers comprise a first plurality of scrapers for removing oil adhering to a plurality of crankshaft counterweights, and a second plurality of scrapers for removing oil adhering to the large ends of a plurality of connecting rods.

7. A combination bearing beam and crankshaft-interactive oil management device according to claim 1, further comprising a plurality of windows formed in said baffle members, with said windows cooperating with said scrapers such that oil captured by said scrapers will flow through said windows and into said crankcase sump.

8. A combination bearing beam and crankshaft-interactive oil management device according to claim 1, wherein said scrapers are supported in part by said laterally extending beam elements.

9. A combination bearing beam and crankshaft-interactive oil management device according to claim 1, wherein said rotating assembly comprises a crankshaft.

10. An internal combustion engine, comprising:
a cylinder block;
a crankshaft;
a plurality of main bearing caps for mounting said crankshaft within said cylinder block; and
a combination bearing beam and crankshaft-interactive oil management device for an internal combustion engine, comprising:
a plurality of longitudinally extending beam elements fastened to said plurality of main bearing caps;
a plurality of laterally extending beam elements formed integrally with said longitudinally extending beam elements, with one of said laterally extending beam elements underlying each of said main bearing caps; and
a plurality of baffle members extending between said longitudinally and laterally extending beam elements, with said baffle members defining a plurality of scrapers for capturing oil adhering to said crankshaft as said crankshaft rotates, and a plurality of windows formed in said baffle members, with said windows cooperating with said scrapers such that oil captured by said scrapers will flow through said windows and into a crankcase sump.

11. An internal combustion engine according to claim 10, wherein said scrapers comprise a first plurality of scrapers for removing oil adhering to a plurality of crankshaft counterweights, and a second plurality of scrapers for removing oil adhering to the large ends of a plurality of connecting rods.

12. An internal combustion engine according to claim 10, wherein said baffle members further comprise separator elements for minimizing direct contact between oil within said crankcase sump and said crankshaft.
